(19) United States
(12) Patent Application Publication
(10) Pub. No.: US 2018/0281513 A1
(43) Pub. Date: Oct. 4, 2018

(54) WHEEL END SENSOR MOUNTING ASSEMBLY FOR HEAVY-DUTY VEHICLES

(71) Applicant: Hendrickson USA, L.L.C., Itasca, IL (US)

(72) Inventors: Dhawal P. Dharaiya, Twinsburg, OH (US); Keith M. Ernenwein, North Canton, OH (US); Nicholas M. Meyer, Wadsworth, OH (US)

(21) Appl. No.: 15/925,966

(22) Filed: Mar. 20, 2018

Related U.S. Application Data
(60) Provisional application No. 62/479,396, filed on Mar. 31, 2017.

(51) Int. Cl. B60B 19/00; B60B 7/00; F16J 15/08

(52) U.S. Cl. CPC B60B 19/00; B60B 7/0013; F16J 15/0818; B60B 2310/318; B60B 2900/5114; B60B 2900/212; B60B 2900/5118; B60B 2900/5112; B60B 2900/141

(57) ABSTRACT

A mounting assembly for mounting a wheel end sensor in a heavy-duty vehicle hubcap that includes at least one adhesive disposed between the wheel end sensor, hubcap, and/or components of the wheel end sensor mounting assembly to prevent aqueous road contaminants from entering the wheel end assembly and prevent lubricants from exiting the wheel end assembly during operation of the vehicle. According to one aspect of the wheel end sensor mounting assembly, the adhesive is delivered via one or more gaskets formed of a hydrophobic or non-wicking material. The one or more gaskets are disposed between the wheel end sensor, the hubcap, and/or components of the wheel end sensor mounting assembly. The one or more gaskets and the adhesives provide sealing interfaces between the components.

### CROSS-REFERENCE TO RELATED APPLICATION

This application claims the benefit of U.S. Provisional Patent Application Ser. No. 62/479,396, filed Mar. 31, 2017.

### BACKGROUND OF THE INVENTION

### Technical Field

The invention relates to wheel end sensors for use in heavy-duty vehicles. In particular, the invention is directed to a mounting assembly for mounting a wheel end sensor in a hubcap of a wheel end assembly of a heavy-duty vehicle. The wheel end sensor mounting assembly includes an adhesive disposed between the wheel end sensor, hubcap, and/or wheel end sensor mounting assembly components. The adhesive provides improved sealing between the components to minimize the potential for road contaminants to migrate into the wheel end assembly and/or minimize leakage of lubricant out of the wheel end assembly, thereby minimizing potential damage to components of the wheel end assembly, and decreasing vehicle maintenance and repair costs.

### Background Art

For many years, the heavy-duty vehicle industry has been utilizing wheel end assemblies which are mounted on each end of one or more axles. Each wheel end assembly typically includes a wheel hub rotatably mounted on a bearing assembly that is mounted on an outboard end of the axle, commonly known as an axle spindle. The bearing assembly includes an inboard bearing and an outboard bearing, which may be separated by a bearing spacer. An axle spindle nut assembly secures the bearing assembly on the axle spindle typically by threadably engaging threads that are cut into an exterior surface of the outboard end of the axle spindle. In addition to retaining the position of the bearings and any spacer, the axle spindle nut assembly may be used to preload the bearings, and any bearing spacer, to a predetermined level. A main seal is rotatably mounted on an inboard end of the wheel hub and the bearing assembly in abutment with the axle spindle, resulting in a closed or sealed wheel end assembly.

As is known, for normal operation of the wheel end assembly to occur, the bearing assembly and surrounding components must be well lubricated with grease or oil. Therefore, the wheel end assembly also must be sufficiently sealed to prevent leakage of lubricant and to prevent contaminants from entering the wheel end assembly, both of which could be detrimental to the performance of the wheel end assembly. Generally, the sealing is accomplished by mounting a hubcap on an outboard end of the wheel hub adjacent to and outboard from the axle spindle nut assembly. While most wheel end assemblies include these general features, the design and arrangement of the wheel hub, bearing assembly, hubcap, main seal, and other components, as well as the axle spindle, vary according to the specific vehicle design and its anticipated uses.

It is desirable to monitor operating conditions of the wheel end assembly in order to determine if issues with any of the wheel end assembly components exist. For example, it is desirable to monitor the temperature of the wheel end assembly, as a consistently high temperature may indicate a lack of lubricant or improper functioning of the bearing assembly. It is also desirable to monitor the vibration experienced in the wheel end assembly, as a consistently high level of vibration may also indicate improper functioning of the bearing assembly.

In the event that undesirable levels of one or more of the monitored conditions exist, it may be possible to stop operation of the vehicle and/or perform maintenance on the vehicle to repair or replace problematic wheel end assembly components before failure of those components takes place. When failure of a wheel end component occurs, there may be damage to associated components, which can greatly increase the cost and the time to repair the wheel end assembly, resulting in increased vehicle downtime and lost revenue. Thus, when the vehicle can be stopped and/or components can be replaced before failure occurs, it may be possible to significantly reduce the cost and the time that is required to repair the wheel end assembly. As a result, wheel end sensors capable of detecting and monitoring wheel end assembly conditions such as temperature, vibration, moisture, and/or other parameters were mounted within various locations around, on, or in the wheel end assembly to monitor such conditions.

One such mounting location for a wheel end sensor for heavy-duty vehicles is in the hubcap of the wheel end assembly. Mounting the wheel end sensor in the hubcap of a wheel end assembly is often desirable due to the relatively protected environment in the hubcap, as well as the ease of accessibility for adjustment, repair, and/or replacement of the wheel end sensor mounted in the hubcap. In addition, mounting the wheel end sensor in the hubcap is often desirable due to packaging constraints of the wheel end assembly of certain configurations, such as components of a tire inflation system being disposed within components of the wheel end assembly. In order for the wheel end assembly to accommodate such components, the wheel end sensor is typically mounted in the vehicle hubcap between a hubcap outboard wall and a hubcap side wall by utilizing a wheel end sensor mounting assembly.

It is important to seal the wheel end assembly to prevent contaminants, such as road debris and road splash, from entering the wheel end assembly and/or prevent lubricant from exiting the wheel end assembly. Prior art wheel end sensor mounting assemblies for mounting wheel end sensors in heavy-duty vehicle hubcaps generally employ one or more gaskets to provide sealing between the wheel end sensor, the hubcap, and/or components of the wheel end sensor mounting assembly. The gasket or gaskets is/are generally disposed between the wheel end sensor, the hubcap, and/or other wheel end assembly mounting components. The gaskets employed by prior art wheel end sensor mounting assemblies are typically formed of a compressible pressed fibrous material, such as cellulose fiber. The gaskets are compressed between the wheel end sensor, hubcap, and/or wheel end sensor mounting assembly components to provide sealing between the components.

While generally satisfactory for their intended uses, gaskets formed of fibrous materials can potentially absorb aqueous road contaminants, such as road splash, during operation of the vehicle. Due to the wicking properties associated with such fibrous materials, the migration of aqueous road contaminants through the sealing interfaces between the wheel end sensor, hubcap, and/or wheel end sensor mounting assembly components, and into the hubcap, and thus the wheel end assembly, may occur. Such gaskets may also allow over time, corrosion of fasteners disposed in the openings. The fasteners attach the components to one another, possibly resulting in reduced clamping force between the components due to corrosion. This in turn can compromise sealing between the components and possibly allow contaminants to enter the interior of the hubcap, and thus the wheel end assembly. This can also allow lubricant to exit from the interior of the wheel end assembly. The migration of contaminants into the wheel end assembly and/or exit of lubricant out of the wheel end assembly can potentially cause damage to components within the wheel end assembly. Such damage may be to the wheel hub bearing assemblies, which may result in undesirable performance of the wheel end assembly and/or require servicing or replacement of the components, causing vehicle downtime and increased labor time and increased cost to operate the vehicle.

As a result, there is need in the art for an improved wheel end sensor mounting assembly for mounting a wheel end sensor in a hubcap of a heavy-duty vehicle, which eliminates the potential issues associated with prior art wheel end sensor mounting assemblies. Such an improved wheel end sensor mounting assembly provides improved sealing between the hubcap, wheel end sensor, and/or wheel end sensor mounting assembly components. The wheel end sensor mounting assembly of the disclosed subject matter satisfies these needs and overcomes limitations, disadvantages, and drawbacks of the prior art.

### BRIEF SUMMARY OF THE INVENTION

The disclosed subject matter provides a mounting assembly for mounting a wheel end sensor in a hubcap that improves sealing between components of the wheel end assembly. The wheel end sensor mounting assembly of the disclosed subject matter minimizes the potential for road contaminants to migrate into the wheel end assembly. The wheel end sensor mounting assembly of the disclosed subject matter provides a mounting assembly for mounting a wheel end sensor in a hubcap that minimizes leakage of lubricant out of the wheel end assembly.

The improved mounting assembly for mounting a wheel end sensor in a hubcap of a heavy-duty vehicle of the disclosed subject matter has at least one adhesive disposed adjacent to the wheel end sensor and the hubcap. The adhesive forms a sealing interface to the wheel end sensor and the hubcap. The sealing interface prevents aqueous road contaminants from entering said wheel end assembly and preventing lubricants from exiting the wheel end assembly.

### BRIEF DESCRIPTION OF THE SEVERAL VIEWS OF THE DRAWINGS

A wheel end sensor mounting assembly for a heavy-duty vehicle of the disclosed subject matter, illustrative of the best mode which is contemplated applying the principles, is set forth in the following description and is shown in the drawings, in which:

FIG. 1 is a fragmentary cross-sectional perspective view of a prior art wheel end assembly having a wheel end sensor for use in a heavy-duty vehicle;

FIG. 2 is an exploded perspective view of a prior art hubcap incorporating the wheel end sensor of FIG. 1;

FIG. 3 is an exploded perspective view of a hubcap incorporating a wheel end sensor of a heavy-duty vehicle wheel end assembly according to an aspect of the disclosed subject matter;

FIG. 4 is an exploded perspective view, looking in the inboard direction, of the wheel end assembly hubcap illustrated in FIG. 3, and showing the wheel end sensor mounted in a component of the hubcap;

FIG. 5 is an enlarged exploded perspective view, partially in cross-section, of the wheel end sensor mounting assembly of FIG. 3, taken approximately along line 5-5 in FIG. 4; and

FIG. 6 is an enlarged fragmentary cross-sectional view of a gasket of the wheel end sensor mounting assembly of FIG. 3, taken approximately along line 6-6 in FIG. 3.

Similar numerals refer to similar parts throughout the drawings.

### DETAILED DESCRIPTION OF THE INVENTION

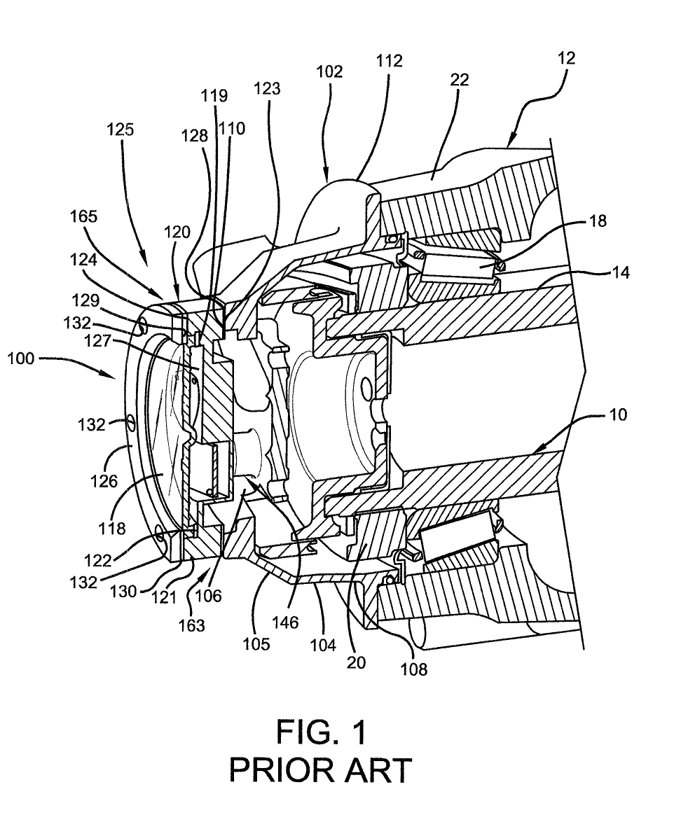

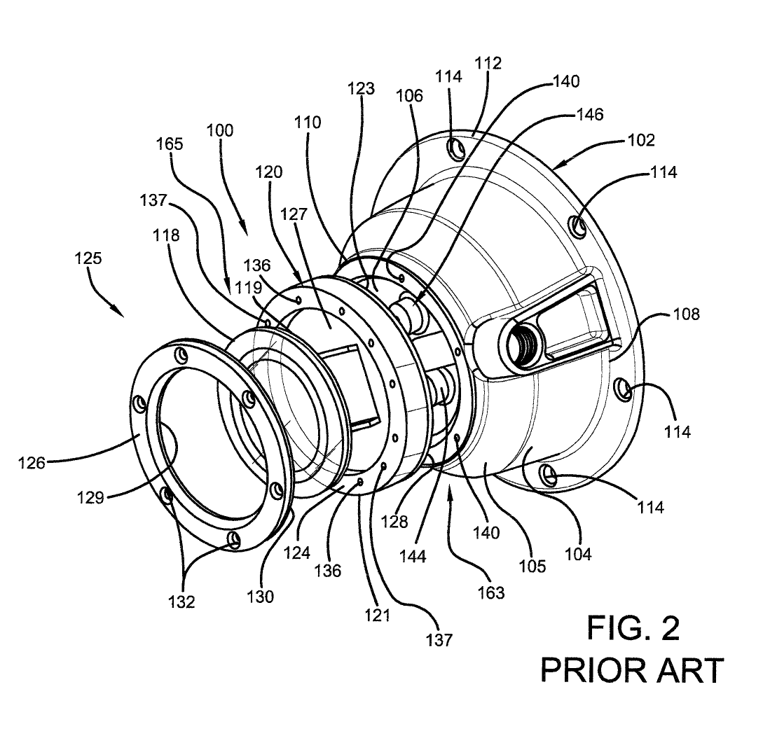

In order to better understand the wheel end sensor mounting assembly of the disclosed subject matter and the environment in which it operates, a heavy-duty vehicle wheel end assembly with a wheel end sensor mounted in a hubcap utilizing a prior art wheel end sensor mounting assembly is shown in FIGS. 1 and 2.

With reference to FIG. 1, a heavy-duty vehicle (not shown) typically includes one or more axles 10 depending from and extending transversely under the vehicle. Heavy-duty vehicles include trucks and tractor-trailers or semi-trailers. The tractor-trailers or semi-trailers typically are equipped with one or more trailers. Reference herein shall be made generally to a heavy-duty vehicle for the purpose of convenience, with the understanding that such reference includes trucks, tractor-trailers and semi-trailers, and trailers thereof. Each axle 10 has two ends, with a wheel end assembly 12 mounted on each one of the ends. For the purposes of convenience and clarity, only one end of axle 10 and its respective wheel end assembly 12 will be described.

Axle 10 includes a central tube (not shown). An axle spindle 14 is integrally connected to each respective end of the central tube by any suitable means, such as welding. Wheel end assembly 12 includes a bearing assembly having an inboard bearing (not shown) and an outboard bearing 18 mounted on the outboard end of axle spindle 14. A spindle nut assembly 20 threadably engages the outboard end of axle spindle 14 and secures the inboard bearing and outboard bearing 18 in place. A wheel hub 22 is mounted for rotation relative to axle spindle 14 by the inboard bearing and outboard bearing 18, as is known. A main continuous seal (not shown) is rotatably mounted on the inboard end of wheel end assembly 12 and closes the inboard end of the wheel end assembly.

In a typical heavy-duty vehicle dual-wheel configuration that employs, for example, drum brakes, a plurality of threaded bolts (not shown) are used to mount a brake drum (not shown) of a drum brake assembly (not shown) and at least one wheel rim (not shown) on the wheel end assembly 12. A tire (not shown) is mounted on the wheel rim, as is known. Alternatively, disc brake (not shown) assemblies rather than drum brake assemblies may be mounted on wheel end assembly 12 in a known manner without affecting the overall concept or operation of the disclosed subject matter.

Wheel end assembly 12 includes a hubcap 102, which is of a type capable of accommodating components of a tire inflation system 146. Hubcap 102 includes a cylindrical side wall 104. Hubcap 102 includes a frustoconical transition portion 105 integrally formed with and extending outboardly from side wall 104. Hubcap 102 includes an intermediate wall 106 integrally formed with transition portion 105. Intermediate wall 106 extends perpendicular to side wall 104. Intermediate wall 106 provides mounting support for components of tire inflation system 146, which is of the type shown and described in U.S. Pat. No. 9,132,704, and is owned by the same Assignee of the disclosed subject matter, Hendrickson USA, L.L.C.

With reference to FIGS. 1 and 2, a radially-extending flange 112 is formed on an inboard end portion 108 of side wall 104, and is formed with a plurality of bolt openings 114 (FIG. 2) through which a plurality of bolts (not shown) are disposed to secure hubcap 102 to the outboard end of wheel hub 22 (FIG. 1). More specifically, each one of the plurality of bolts passes through a respective one of plurality of bolt openings 114, and threadably engages a respective one of a plurality of aligned threaded openings (not shown) formed in the outboard end of wheel hub 22. Hubcap 102 also includes a discrete outboard wall 118 to seal the outboard end of wheel end assembly 12. Outboard wall 118 is typically tinted, transparent, or translucent to enable visual inspection of components of a wheel end sensor 100 and/or lubricant levels with certain configurations of the wheel end sensor.

Wheel end sensor 100 is mounted in hubcap 102. Wheel end sensor 100 is of the type described in U.S. Patent Application Publication No. 2016/0076973, which is owned by the same Assignee of the disclosed subject matter, Hendrickson USA, L.L.C. Wheel end sensor 100 includes a sensor block 120 formed with a perimeter ring 121 for mounting wheel end sensor 100 in hubcap 102. Sensor block 120 also includes a component mounting block 127 integrally formed inside of perimeter ring 121. Component mounting block 127 houses electronic components of wheel end sensor 100, such as a control board, a power source (not shown), instrumentation for monitoring wheel end assembly operating conditions, and a light emitting diode (LED) readout for providing a vehicle operator with a visual indication of undesirable operating conditions within wheel end assembly 12. It will be appreciated that other ways of communicating conditions sensed by wheel end sensor 100 could be utilized, such as wireless transmitters (not shown).

Sensor block 120 is mounted in hubcap 102 utilizing a prior art wheel end sensor mounting assembly 125. Prior art wheel end sensor mounting assembly 125 generally includes a retaining ring 126, a ring-shaped first gasket 128, and a ring-shaped second gasket 130. First gasket 128 is disposed between an inboard surface 123 of perimeter ring 121 and an outboard end surface 110 of transition portion 105 of hubcap 102. First gasket 128 is formed with a plurality of circumferentially spaced openings (not shown). Perimeter ring 121 is formed with a plurality of circumferentially spaced first openings 136 (FIG. 2), which extend transversely through the perimeter ring. First openings 136 are circumferentially aligned with the plurality of openings (not shown) of first gasket 128 and a plurality of circumferentially spaced openings 140 formed in outboard end surface 110 of transition portion 105 of hubcap 102. A plurality of bolts (not shown) or other mechanical fasteners are aligned and inserted through first openings 136 of perimeter ring 121, the plurality of openings of first gasket 128, and plurality of openings 140 of outboard end surface 110 to secure sensor block 120, and thus wheel end sensor 100, to transition portion 105 of hubcap 102.

With reference to FIG. 1, outboard wall 118 of hubcap 102 seats in a circumferentially extending recess 122 formed in an outboard surface 124 of perimeter ring 121 so that its outboard surface is coplanar with the outboard surface of the perimeter ring. A gasket 119 or an O-ring (not shown) is disposed between outboard wall 118 of hubcap 102 and circumferentially extending recess 122 to provide a seal between the outboard wall and the recess to protect electronic components of wheel end sensor 100 from entry of contaminants. Outboard wall 118 enables a vehicle operator to view the visual indication of undesirable operating conditions within wheel end assembly 12 in configurations of wheel end sensor 100 which include a visual indicator, such as an LED readout.

Second gasket 130 is disposed between retaining ring 126 and the coplanar junction of the outboard surface of outboard wall 118 and outboard surface 124 of perimeter ring 121. Second gasket 130 is formed with a plurality of circumferentially spaced openings (not shown). Retaining ring 126 is formed with plurality of circumferentially spaced openings 132 which extend through the retaining ring and are circumferentially aligned with the plurality of openings of second gasket 130 and a plurality of circumferentially spaced non-continuous second openings 137 formed in outboard surface 124 of perimeter ring 121. Second openings 137 extend inboardly partially into perimeter ring 121. A plurality of bolts (not shown) or other mechanical fasteners extend through respective aligned openings 132 of retaining ring 126, the plurality of openings of second gasket 130, and into second openings 137 to capture and secure outboard wall 118 of hubcap 102 within recess 122 between retaining ring 126 and wheel end sensor 100. Because wheel end sensor 100 is also attached to transition portion 105 of hubcap 102 in the manner described above, the wheel end sensor is effectively mounted in the hubcap between outboard wall 118 and the transition portion.

First and second gaskets 128, 130 of prior art wheel end sensor mounting assembly 125 provide a sealing interface 163 between inboard surface 123 of perimeter ring 121 and outboard end surface 110 of transition portion 105 of hubcap 102, as well as a sealing interface 165 between the coplanar outboard wall 118 of the hubcap and outboard surface 124 of the perimeter ring and an inboard surface 129 of retaining ring 126, respectively. First and second gaskets 128, 130 are typically formed of a compressible pressed fibrous material, such as cellulose fiber.

While generally satisfactory for their intended uses, gaskets formed of fibrous materials, such as those utilized to form first and second gaskets 128, 130, can potentially absorb aqueous road contaminants during operation of the heavy-duty vehicle. Such fibrous materials can allow the aqueous road contaminants to wick and migrate through first and second gaskets 128, 130 and into the interior of hubcap 102, and ultimately into wheel end assembly 12. In addition, expansion and contraction due to freezing and thawing during cold weather of water from the aqueous road contaminants absorbed within first and second gaskets 128, 130 can compromise the sealing between hubcap 102 and wheel end sensor 100. This is turn can potentially allow contaminants to enter the interior of hubcap 102, and thus within wheel end assembly 12, and/or allow lubricant to exit from the wheel end assembly. Aqueous road contaminants can also wick through first and second gaskets 128, 130 and migrate into first openings 136 of perimeter ring 121, second openings 137 of the perimeter ring and/or through openings 140 of outboard end surface 110 of hubcap transition portion 105 and in between the threads of the respective bolts or fasteners. Over time, the aqueous road contaminants can corrode the respective bolts or fasteners, which can reduce clamp force of the respective bolts and fasteners and compromise sealing interfaces 163 and 165. This reduced clamping force, in turn, can allow aqueous road contaminants to enter the interior of hubcap 102, and thus within wheel end assembly 12, and/or allow lubricant to exit from the wheel end assembly, potentially resulting in damage to components of the wheel end assembly.

As a result, there is a need for a wheel end sensor mounting assembly for mounting a wheel end sensor in a hubcap which eliminates the potential sealing issues, limitations, disadvantages, and drawbacks associated with prior art wheel end sensor mounting assemblies. Thus, an improved seal between the wheel end sensor, hubcap, and wheel end sensor mounting assembly components is desirable. The disclosed subject matter satisfies these needs, and overcomes the sealing issues, limitations, disadvantages, and drawbacks of prior art wheel end sensor mounting assemblies.

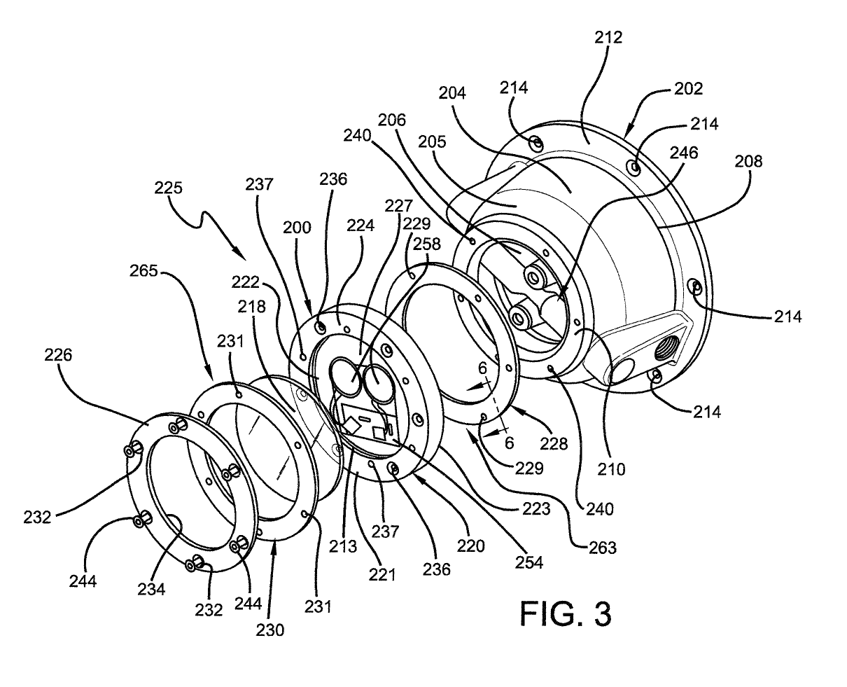

An exemplary wheel end sensor mounting assembly according to an aspect of the disclosed subject matter, is shown in FIGS. 3-6 and is indicated generally at 225. Exemplary aspect wheel end sensor mounting assembly 225 is utilized to mount a wheel end sensor 200 in a hubcap 202 for heavy-duty vehicles and to seal between the hubcap, the wheel end sensor, and/or other wheel end sensor mounting assembly components. Hubcap 202 is similar in structure and function to hubcap 102 described with regard to prior art wheel end sensor mounting assembly 125, and is of the type which is capable of accommodating components of a tire inflation system 246. Hubcap 202 includes a cylindrical side wall 204. Hubcap 202 also includes a frustoconical transition portion 205 integrally formed with and extending outboardly from side wall 204. Hubcap 202 includes an intermediate wall 206 integrally formed with transition portion 205. Intermediate wall 206 extends perpendicular to side wall 204. Intermediate wall 206 provides mounting support for components of tire inflation system 246, which is of the type shown and described in U.S. Pat. No. 9,132,704, and is owned by the same Assignee as the disclosed subject matter, Hendrickson USA, L.L.C. It is to be understood that other shapes and configurations of hubcap 202, including those of side wall 204, transition portion 205, and intermediate wall 206, may be employed without affecting the overall concept or operation of the disclosed subject matter. For example, hubcap 202 could include an integrated dome or cone shape formed as one piece or multiple pieces.

With continued reference to FIG. 3, a radially-extending flange 212 is integrally formed with an inboard end 208 of side wall 204. Radially-extending flange 212 is formed with a plurality of circumferentially spaced bolt openings 214 through which a plurality of bolts (not shown) are disposed to secure hubcap 202 to the outboard end of a wheel hub (not shown) of a wheel end assembly (not shown), as is known. More specifically, each one of the plurality of bolts passes through a respective one of plurality of bolt openings 214, and threadably engages a respective one of a plurality of aligned threaded openings (not shown) formed in an outboard end of the wheel hub. Hubcap 202 also includes a discrete outboard wall 218 to seal an outboard end of a wheel end assembly.

Wheel end sensor 200 is mounted in hubcap 202 according to one aspect of the disclosed subject matter, as will now be described. Wheel end sensor 200 is of the type described in U.S. Patent Application Publication No. 2016/0076973, assigned to the Applicant of the disclosed subject matter, Hendrickson USA, L.L.C. With reference to FIGS. 3-5, wheel end sensor 200 includes a sensor block 220 formed of a lightweight rigid material, such as aluminum. Sensor block 220 is formed with a perimeter ring 221 for mounting wheel end sensor 200 in hubcap 202 utilizing exemplary aspect wheel end sensor mounting assembly 225, as will be described below. Sensor block 220 also includes a component mounting block 227 integrally formed inside of perimeter ring 221. Component mounting block 227 is formed with a plurality of different sized and shaped recesses 252 for receiving components of wheel end sensor 200.

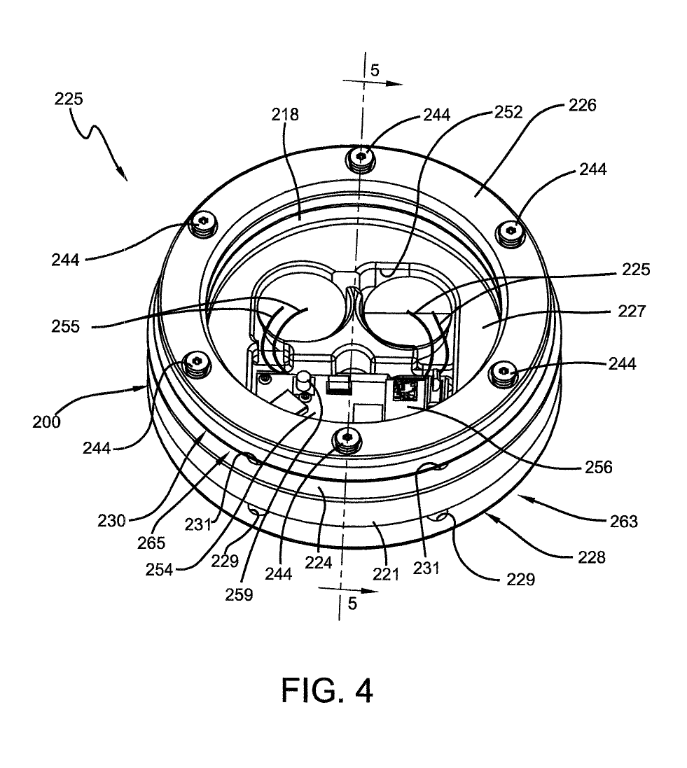

With particular reference to FIG. 4, a main circuit board 254 and a pair of batteries 258 for supplying electrical energy to the circuit board via a respective pair of wires 255, are attached to and housed within recesses 252 by any suitable means known in the art. Main circuit board 254 includes sensor instrumentation (not shown) for sensing certain designated operational conditions and generates data signals in a known manner. Main circuit board 254 includes one or more processors 256 that receive the data signals from the sensor instrumentation to collect and processes the sensed data. Wheel end sensor 200 also includes a light emitting diode (LED) readout 259 operatively connected to main circuit board 254, which provides a visual indicator of undesirable operating conditions that may require attention or service within the wheel end assembly as programmed in the main circuit board. Outboard wall 218 is tinted, transparent, or translucent to enable a vehicle operator to view LED readout 259 of main circuit board 254 and/or enable visual inspection of components of wheel end sensor 200.

It is to be understood that the above-described configuration of wheel end sensor 200 is by way of example. Adaptations and adjustments to the configuration and/or components of wheel end sensor 200 may be employed as is known without affecting the overall concept or operation of the disclosed subject matter.

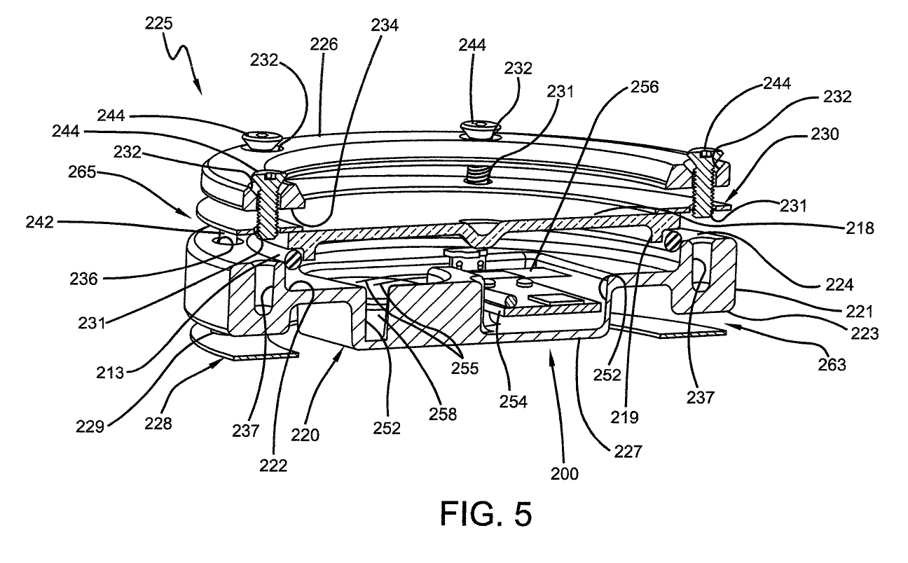

Exemplary aspect wheel end sensor mounting assembly 225 of the disclosed subject matter includes a retaining ring 226, a ring-shaped first gasket 228, and a ring-shaped second gasket 230. First gasket 228 is disposed between an inboard surface 223 of perimeter ring 221 and outboard end 210 of transition portion 205 of hubcap 202. With reference to FIGS. 3 and 5, first gasket 228 is formed with a plurality of circumferentially spaced openings 229. Perimeter ring 221 of sensor block 220 is formed with a plurality of circumferentially spaced first openings 236, which extend transversely through the perimeter ring. First openings 236 are circumferentially aligned with plurality of openings 229 of first gasket 228 and a plurality of circumferentially spaced openings 240 formed in outboard end 210 of hubcap transition portion 205. With particular reference to FIG. 5, a plurality of bolts 242 or other mechanical fasteners are received by respective aligned first openings 236 of perimeter ring 221, plurality of openings 229 of first gasket 228, and openings 240 of outboard end 210 of hubcap transition portion 205 to secure sensor block 220, and thus wheel end sensor 200, to the hubcap transition portion.

Outboard wall 218 of hubcap 202 seats in a circumferentially extending recess 222 formed in an outboard surface 224 of perimeter ring 221. More specifically, outboard wall 218 is integrally formed with a circumferential seating structure 219 positioned radially inwardly of the outboard wall radial edge. Circumferential seating structure 219 extends inboardly from an inboard side of outboard wall 218 so that when the outboard wall is seated within recess 222 its outboard surface is coplanar with perimeter ring outboard surface 224. An O-ring 213 is positioned on the inboard surface of outboard wall 218 radially outwardly of circumferential seating structure 219 and provides a seal between the outboard wall and perimeter ring 221 via deformation of the O-ring to protect components of wheel end sensor 200 from entry of contaminants. It is understood that other types of seals could be utilized to seal between outboard wall 218 and perimeter ring 221, such as a polymeric gasket, without affecting the overall concept or operation of the present invention.

With reference to FIGS. 3-5, second gasket 230 is disposed between an inboard surface 234 of retaining ring 226 and the coplanar junction of outboard surface 224 of perimeter ring 221 and the outboard surface of outboard wall 218 of hubcap 202 to prevent direct contact between the retaining ring and perimeter ring and hubcap outboard wall. Second gasket 230 is formed with a plurality of circumferentially spaced openings 231. Retaining ring 226 is formed with a plurality of circumferentially spaced openings 232 positioned near the radially outward edge of the retaining ring. Openings 232 are circumferentially aligned with plurality of openings 231 of second gasket 230 and a plurality of circumferentially spaced second openings 237 formed in outboard surface 224 of perimeter ring 221 offset from first openings 236. With particular reference to FIG. 5, second openings 237 extend inboardly partially into perimeter ring 221. A plurality of bolts or screws 244, or other suitable mechanical fasteners, are received by respective aligned openings 232 of retaining ring 226, plurality of openings 231 of second gasket 230, and second openings 237 of perimeter ring 221 to capture and removably secure outboard wall 218 of hubcap 202 within recess 222 between the retaining ring and wheel end sensor 200. Because wheel end sensor 200 is also attached to transition portion 205 of hubcap 202 in the manner described above, wheel end sensor 200 is effectively mounted in hubcap 202 between outboard wall 218 and the transition portion. In addition, because second openings 237 are formed in perimeter ring 221 offset from first openings 236 utilized to secure wheel end sensor 200 to transition portion 205 of hubcap 202 in accordance with the disclosure above, retaining ring 226, and thus outboard wall 218, can be removed to access/service the wheel end sensor, such as to replace one or more of batteries 258, without removing the sensor from the hubcap transition portion, thereby protecting the wheel end assembly from disturbance and preventing contaminants from being introduced into components of the wheel end assembly or egress of lubricant from the wheel end assembly.

First and second gaskets 228, 230 of exemplary aspect wheel end sensor mounting assembly 225 provide a sealing interface 263 between inboard surface 223 of perimeter ring 221 and outboard end 210 of transition portion 205 of hubcap 202, and a sealing interface 265 between coplanar outboard surface of outboard wall 218 of the hubcap and outboard surface 224 of the perimeter ring, and an inboard surface 234 of retaining ring 226, respectively.

In accordance with an important aspect of the disclosed subject matter, exemplary aspect wheel end sensor mounting assembly 225 provides improved sealing between hubcap 202, wheel end sensor 200, and components of the wheel end sensor mounting assembly compared to prior art wheel end sensor mounting assemblies used to mount a wheel end sensor in a prior art hubcap 102, such as wheel end sensor mounting assembly 125 (FIGS. 1-2) described above. More specifically, first gasket 228 provides a structure that renders sealing interface 263 impervious to aqueous road contaminants, preventing the aqueous road contaminants from entering hubcap 202, and thus the wheel end assembly, and preventing lubricant from exiting the interior of the wheel end assembly.

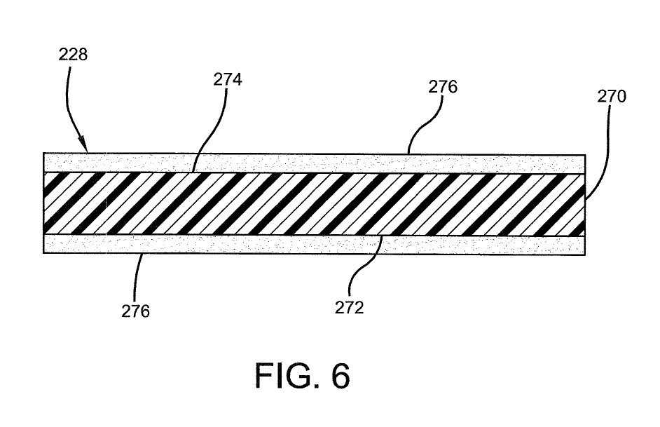

With reference to FIG. 6, a cross-sectional view of first gasket 228 is shown. First gasket 228 includes a base 270 with an inboard side 272 and an outboard side 274. Base 270 is formed of a material capable of accepting an adhesive 276. Base 270 preferably is formed of a flexible polymeric material, such as polycarbonate, but could also be formed of other materials, including compressible or non-compressible materials, capable of accepting an adhesive, without affecting the overall concept or operation of the disclosed subject matter. Base 270 also preferably is formed from a hydrophobic or non-wicking material to further provide aqueous resistant sealing properties to second gasket 230.

A relatively flexible and compliant adhesive 276 is received by both inboard and outboard sides 272, 274 of base 270. Adhesive 276 is of a type capable of providing a bond seal impervious to aqueous substances, including aqueous road contaminants, such as an adhesive exhibiting hydrophobic properties. An example of a material which exhibits the aforementioned preferred properties is the 3M™ adhesive transfer tape 467MP. Adhesive 276 could be the same or two different adhesives applied on inboard and outboard sides 272, 274, respectively, without affecting the overall concept or operation of the disclosed subject matter.

As previously discussed, gaskets formed of fibrous materials, such as those utilized to form first and second gaskets 128, 130 of prior art wheel end sensor mounting assembly 125, can potentially absorb aqueous road contaminants during operation of the vehicle, and due to the wicking properties associated with such materials, facilitate the migration of aqueous road contaminants through sealing interfaces between the wheel end sensor, hubcap, and/or wheel end sensor mounting assembly components and into the hubcap, and thus wheel end assembly. In addition, such gaskets can potentially facilitate the migration of aqueous road contaminants into mounting openings of the wheel end sensor, hubcap, and wheel end sensor mounting assembly components, and over time, corrode fasteners disposed in the openings utilized to attach the components to one another and reduce clamp force between the components. This in turn can compromise sealing between the components and allow contaminants to enter the interior of hubcap, and thus the wheel end assembly, and/or allow lubricant to exit the interior of the wheel end assembly. The migration of contaminants into the wheel end assembly and/or exit of lubricant out of the wheel end assembly can potentially cause damage to components within the wheel end assembly, such as the wheel hub bearing assemblies, and result in undesirable performance of the wheel end assembly and/or require servicing or replacement of the components, resulting in vehicle downtime, increased labor time, and increased cost to operate the vehicle.

Because adhesive 276 is received by inboard and outboard sides 272, 274 of first gasket 228, and the gasket is disposed between outboard end 210 of hubcap 202 and inboard surface 223 of wheel end sensor perimeter ring 221 in the manner described above, and due to its chemical properties, the adhesive forms a tight uniform seal at sealing interface 263 between the perimeter ring and the hubcap outboard end. In this manner, exemplary aspect wheel end sensor mounting assembly 225 renders sealing interface 263 impervious to aqueous road contaminants, which effectively prevents aqueous road contaminates from entering hubcap 202, and thus the wheel end assembly, as well as prevents lubricant from exiting from the interior of the wheel end assembly.

Second gasket 230 can optionally include an adhesive, such as adhesive 276, applied to the inboard and outboard sides of the gasket. In such circumstances, second gasket 230 functions similarly to first gasket 228, with the adhesive (not shown) on the second gasket outboard and inboard sides forming a tight uniform seal at sealing interface 265 between inboard surface 234 of retaining ring 226 and the interface of the outboard surface of outboard wall 218 and outboard surface 224 of perimeter ring 221. In addition, because second gasket 230 is positioned over the interface of the outboard surface of outboard wall 218 and outboard surface 224 of perimeter ring 221, the second gasket effectively seals the interface, eliminating the need to utilize O-ring 213 to seal between the outboard wall and the perimeter ring. In this manner, exemplary aspect wheel end sensor mounting assembly 225 renders sealing interfaces 263 and 265, impervious to aqueous road contaminants, which effectively prevents aqueous road contaminates from entering hubcap 202, and thus the wheel end assembly, as well as prevents lubricant from exiting from the interior of the wheel end assembly, and also protects components of wheel end sensor 200 from entry of contaminants.

Alternatively, adhesive 276 can be applied directly between outboard end 210 of hubcap 202 and inboard surface 223 of wheel end sensor perimeter ring 221 without first gasket 228, and optionally between inboard surface 234 of retaining ring 226 and the interface of the outboard surface of outboard wall 218 and outboard surface 224 of perimeter ring 221 without second gasket 230, to provide a seal impervious to aqueous road contaminants. Such direct application can be achieved by any suitable means capable of delivering adhesive 276, such as by manual application or automated process, without affecting the overall concept or operation of the disclosed subject matter. In such applications, adhesive 276 could include any composition which could be directly applied, such as caulk or Room Temperature Vulcanizing (RTV) silicone, without affecting the overall concept or operation of the disclosed subject matter.

Thus, the exemplary aspect wheel end sensor mounting assembly of the disclosed subject matter for mounting a wheel end sensor in a heavy-duty vehicle hubcap provides improved sealing between the wheel end sensor, hubcap, and/or wheel end sensor mounting assembly components to minimize the potential for road contaminants to migrate into wheel end assembly and/or minimize the potential for leakage of lubricant out of the wheel end assembly, thereby minimizing potential damage to components of the wheel end assembly, and decreasing vehicle maintenance and repair costs.

It is to be understood that the structure of the above-described wheel end sensor mounting assembly may be altered or rearranged, or certain components omitted or added, without affecting the overall concept or operation of the invention. It is also to be understood that the disclosed subject matter finds application in all types of axle spindle and wheel end assemblies known to those skilled in the art, including other types of axle spindles and wheel end assemblies than those shown and described herein and known to those skilled in the art, without affecting the concept or operation of the invention. Moreover, it is to be understood that the disclosed subject matter finds application in all types of hubcaps known to those skilled in the art, including other types of hubcaps than those shown and described herein without affecting the concept or operation of the invention. It is also to be understood that wheel end sensor 200 shown above is by way of example and is not intending to be limiting on the disclosed subject matter. Wheel end sensors with different structures, arrangements, and functions than wheel end sensor 200 could be mounted within a heavy-duty vehicle hubcap utilizing the wheel end sensor mounting assembly of the disclosed subject matter without affecting the concept or operation of the disclosed subject matter. While reference herein has been made generally to a heavy-duty vehicle for the purpose of convenience, it has been with the understanding that such reference includes trucks, tractor-trailers or semi-trailers, and trailers thereof.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the disclosed subject matter has been described with reference to a specific aspect. It shall be understood that this illustration is by way of example and not by way of limitation, as the scope of the invention is not limited to the exact details shown or described. Potential modifications and alterations will occur to others upon a reading and understanding of this disclosure, and it is understood that the invention includes all such modifications and alterations and equivalents thereof.

Having now described the features, discoveries and principles of the invention, the manner in which the wheel end sensor mounting assembly of the disclosed subject matter is used and installed, the characteristics of the construction, arrangement and method steps, and the advantageous, new and useful results obtained; the new and useful structures, devices, elements, arrangements, processes, parts and combinations are set forth in the appended claims.

What is claimed is:

1. A mounting assembly for mounting a wheel end sensor in a hubcap of a heavy-duty vehicle wheel end assembly comprising:
at least one adhesive disposed adjacent to said wheel end sensor and said hubcap, said adhesive forming a sealing interface to the wheel end sensor and the hubcap, said sealing interface preventing aqueous road contaminants from entering said wheel end assembly and preventing lubricants from exiting the wheel end assembly.

2. The mounting assembly for mounting a wheel end sensor in a hubcap of a heavy-duty vehicle wheel end assembly of claim 1, wherein said hubcap includes:
a cylindrical sidewall with an inboard end and an outboard end, said inboard end being attached to a wheel hub of said wheel end assembly; and
an outboard wall extending generally perpendicular to said side wall, said wheel end sensor being disposed within said hubcap between said cylindrical sidewall outboard end and said outboard wall.

3. The mounting assembly for mounting a wheel end sensor in a hubcap of a heavy-duty vehicle wheel end assembly of claim 2, wherein a first adhesive is disposed adjacent to and provides a sealing interface to said cylindrical sidewall outboard end and said wheel end sensor.

4. The mounting assembly for mounting a wheel end sensor in a hubcap of a heavy-duty vehicle wheel end assembly of claim 3, wherein a second adhesive is disposed adjacent to and provides a sealing interface to said wheel end sensor and said outboard wall.

5. The mounting assembly for mounting a wheel end sensor in a hubcap of a heavy-duty vehicle wheel end assembly of claim 2, further comprising:
a first gasket, a first adhesive being applied on said first gasket, the first gasket being disposed adjacent to said cylindrical side wall outboard end and said wheel end sensor; and
a second gasket, the second gasket being disposed adjacent to the wheel end sensor and said outboard wall.

6. The mounting assembly for mounting a wheel end sensor in a hubcap of a heavy-duty vehicle wheel end assembly of claim 5, further comprising an O-ring disposed between said wheel end sensor and said outboard wall, said O-ring sealing between the wheel end sensor and the outboard wall.

7. The mounting assembly for mounting a wheel end sensor in a hubcap of a heavy-duty vehicle wheel end assembly of claim 5, wherein a second adhesive is applied on said second gasket.

8. The mounting assembly for mounting a wheel end sensor in a hubcap of a heavy-duty vehicle wheel end assembly of claim 5, wherein said first adhesive is applied on an inboard side and an outboard side of said first gasket.

9. The mounting assembly for mounting a wheel end sensor in a hubcap of a heavy-duty vehicle wheel end assembly of claim 5, wherein said first gasket and said second gasket are formed of a hydrophobic material.

10. The mounting assembly for mounting a wheel end sensor in a hubcap of a heavy-duty vehicle wheel end assembly of claim 9, wherein said hydrophobic material is a flexible polymeric material.

11. The mounting assembly for mounting a wheel end sensor in a hubcap of a heavy-duty vehicle wheel end assembly of claim 10, wherein said flexible polymeric material is polycarbonate.

12. The mounting assembly for mounting a wheel end sensor in a hubcap of a heavy-duty vehicle wheel end assembly of claim 4, further comprising a retainer ring, said retainer ring being positioned outboardly of said outboard wall and securing the outboard wall to said wheel end sensor, said second adhesive being disposed between the retainer ring and the outboard wall and the wheel end sensor.

13. The mounting assembly for mounting a wheel end sensor in a hubcap of a heavy-duty vehicle wheel end assembly of claim 5, wherein an outboard surface of said wheel end sensor is formed with a recess, said outboard wall being seated within said recess, said outboard surface of the wheel end sensor and an outboard surface of said outboard wall being coplanar, said second gasket extending over a junction between said wheel end sensor and the outboard wall, a retainer ring being positioned outboardly of the second gasket and securing said outboard wall to the wheel end sensor.

14. The mounting assembly for mounting a wheel end sensor in a hubcap of a heavy-duty vehicle wheel end assembly of claim 13, wherein said retainer ring is formed with a plurality of circumferentially spaced openings and said wheel end sensor is formed with a corresponding plurality of circumferentially spaced first openings, a first plurality of fasteners being disposed through said retainer ring openings and said first openings to secure the retainer ring to the wheel end sensor.

15. The mounting assembly for mounting a wheel end sensor in a hubcap of a heavy-duty vehicle wheel end assembly of claim 14, wherein said wheel end sensor is formed with a plurality of circumferentially spaced second openings offset said first openings, said cylindrical side wall outboard end being formed with a plurality of circumferentially spaced openings aligned with said second openings, a second plurality of fasteners being disposed through said second openings and said plurality of openings to secure the wheel end sensor to the cylindrical sidewall outboard end.

16. The mounting assembly for mounting a wheel end sensor in a hubcap of a heavy-duty vehicle wheel end assembly of claim 15, wherein said first openings and said second openings are formed on a perimeter ring of said wheel end sensor.

17. The mounting assembly for mounting a wheel end sensor in a hubcap of a heavy-duty vehicle wheel end assembly of claim 7, wherein said first adhesive and said second adhesive include different compositions.

18. A mounting assembly for mounting a wheel end sensor in a hubcap of a heavy-duty vehicle wheel end assembly comprising:
a wheel end sensor, said wheel end sensor including a mounting structure;
a hubcap, said hubcap including:
a cylindrical sidewall with an inboard end and an outboard end, said inboard end being attached to a wheel hub of said wheel end assembly; and
an outboard wall extending generally perpendicular to said side wall, said wheel end sensor being disposed within said hubcap between said cylindrical sidewall outboard end and said outboard wall and being attached to the hubcap via said mounting structure;
a first gasket disposed adjacent to said wheel end sensor mounting structure and said hubcap cylindrical sidewall outboard end;
a second gasket disposed adjacent to the wheel end sensor mounting structure and said outboard wall; and
an adhesive on at least one side of said first gasket and/or said second gasket, said adhesive and the first gasket and the second gasket forming a sealing interface between said wheel end sensor and the hubcap.

19. The mounting assembly for mounting a wheel end sensor in a hubcap of a heavy-duty vehicle wheel end assembly of claim 18, wherein said adhesive is on both sides of said first gasket and/or said second gasket.
